(19) United States
(12) Patent Application Publication
(10) Pub. No.: US 2007/0170329 A1
(43) Pub. Date: Jul. 26, 2007

(54) Multifunctional hanger hook structure

(76) Inventor: I-Lung Li, Sanchong City (TW)

Correspondence Address: BIRCH STEWART KOLASCH & BIRCH, PO BOX 747, FALLS CHURCH, VA, 22040-0747, US

(21) Appl. No.: 11/338,759

(22) Filed: Jan. 25, 2006

(51) Int. Cl. F16B 45/00

(52) U.S. Cl. 248/304

(57) ABSTRACT

The invention relates to a multifunctional hanger hook, comprising of a pedestal base and a hook, respectively. The characteristic of the invention lies in that an anti-slip portion with high friction and set on the bottom of the pedestal base. In addition, a cavity is disposed on the upper surface of the pedestal base near to the rim thereof and a perforation penetrates through the cavity on lateral side of the pedestal base. Accordingly, the hook of the invention is formed as an inverted hook, having said perforation pierced inward into the front end thereof and having a connection formed in the end thereof. Lodging in said pedestal base in one piece. In addition, a round tip is disposed on the end of the hook, the pivot of which for hanging heavy items fall downwards on the vertical extension line of the pedestal base, so the invention is able to achieve a great effect of anti-slippage and enhance the steadiness of hanging a heavy item thereon.

### BACKGROUND OF THE INVENTION

I. Field of the Invention

The present invention refers to a multifunctional hanger hook structure, especially to a multi-functional hanger hook that is applied to hang collected stationery or adornments by a table or on a rack with great effects of anti-slippage, so as to enhance the steadiness of the hanger.

II. Description of the Prior Art

Generally, a conventional hanger hook comprises a pedestal base A and a hook B; the pedestal base A has an anti-slip portion C positioned on the bottom thereof and has a connection D positioned on the lateral side thereof. In addition, the hook B is an inverted hook formed by turning an upright section upwards, extending an upright section downwards and then bending a hook section upwards with the front end of hook B lodged in the connection D of the pedestal base A in one piece. Such a conventional hanger hook is applied to hang an object on the hook B by putting the weight of the object on the pedestal base A. The anti-slip portion C of the pedestal base A is a foam-rubber pad, which has anti-slip effect and thereby enables the hook section to move the position often so as to make an object hung thereon fall on the floor or swayed on the hook. Consequently, such a conventional hanger hook is unable to reach the strong anti-slip effect and hanging steadiness.

### SUMMARY OF THE INVENTION

The main objective of the present invention is to provide a multifunctional hanger hook that is applied to hang collected stationery or adornments by a table or on a rack with a great effect of anti-slippage, so as to enhance the steadiness of the hanger.

To achieve the foregoing objective, the “multifunctional hanger hook” of the invention mainly comprises a pedestal base and a hook with certain measure of areas and weights, respectively. The characteristic of the invention lies in that an anti-slip portion is made of rubber with high friction and set on the bottom of the pedestal base. In addition, a cavity is disposed on the upper surface of the pedestal base near to the rim thereof and a perforation penetrates through the cavity on a lateral side of the pedestal base.

Accordingly, the hook of the invention is formed as an inverted hook, having said perforation pierced inward into the front end thereof and having a connection formed in the end thereof lodging in said pedestal base in one piece. The hook is an inverted hook by forming a short upright section on the front end thereof, extending a longer upright section downwards at 90 degrees, extending a short and slanting curve downwards, and finally, extending a hook shape upwards at the end thereof. In addition, a round tip is disposed on the end of the hook, the pivot of which for hanging heavy items fall downwards on the vertical extension line of the pedestal base, so that the invention is able to achieve a great effect of anti-slippage and enhance the steadiness of hanging a heavy item thereon.

### BRIEF DESCRIPTION OF THE DRAWINGS

FIG. 1 is a prospective view of a prior art.

FIG. 2 is an exploded view of the present invention.

FIG. 3 is a three-dimensional view of the invention.

FIGS. 4A and 4B are prospective views showing the invention in use.

FIGS. 5A and 5B are prospective views showing the bottom of a pedestal base of another embodiment according to the invention.

FIGS. 6A, 6B, 6C and 6D are prospective views showing the bottom of a pedestal base of another embodiment according to the present invention.

FIGS. 7A and 7B are cross-sectional views showing the bottom of a pedestal base of another embodiment according to the present invention; and

FIGS. 8A and 8B respectively show an exploded view and an assembly view of a pedestal base of another embodiment of the invention.

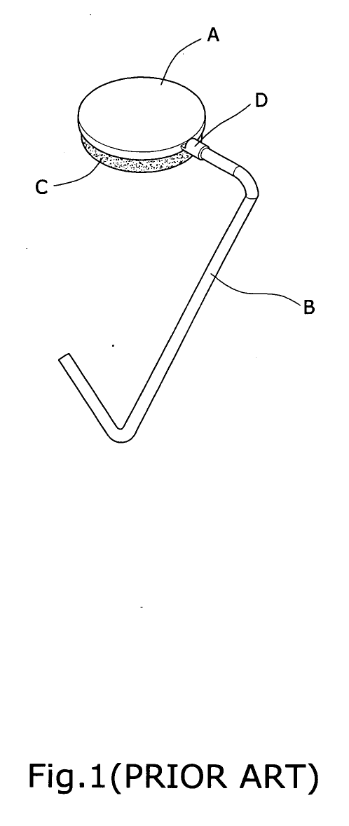

### DESCRIPTION OF THE PREFERRED EMBODIMENT

Further aspects, objects, and desirable features of the invention will be better understood from the detailed description and drawings that follow in which various embodiments of the disclosed invention are illustrated by way of examples.

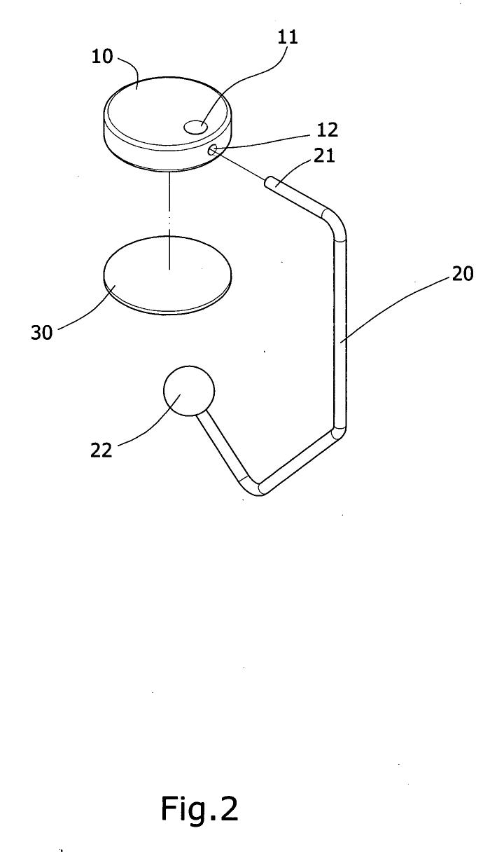

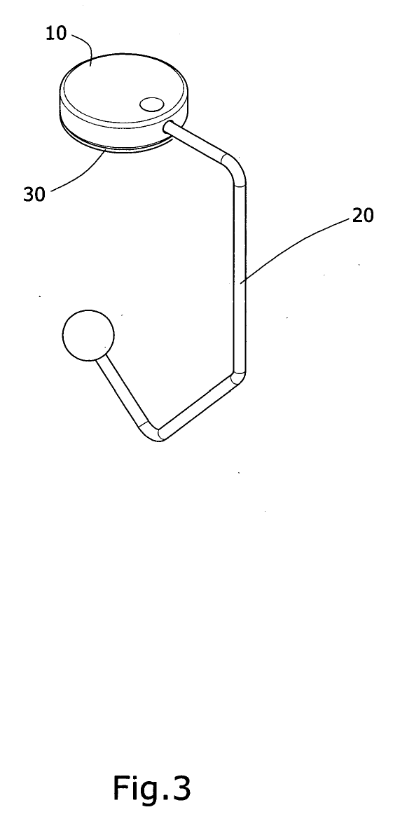

With reference to FIGS. 2 and 3, the “multifunctional hanger hook” of the invention mainly comprises of a pedestal base 10 and a hook 20 with certain measure of areas and weights, respectively, wherein:

The pedestal base has the bottom thereof set an anti-slip portion 30 made of rubber with high friction. In addition, a cavity 11 is disposed on the upper surface of the pedestal base 10 near to the rim thereof and a perforation 12 penetrates through the cavity 11 on a lateral side of the pedestal base 10. The hook 20 is formed as an inverted hook, having said perforation 12 pierced inward into the front end thereof and having a connection 21 formed in the end thereof lodging in said pedestal base 10 in one piece. The hook 20 is an inverted hook which forms a short upright section on the front end thereof, extending a longer upright section downwards at 90 degrees, extending a short and slanting curve downwards, and finally, extending a hook shape upwards at the end thereof. In addition, a round tip 22 is disposed on the end of the hook 20, the pivot of which for hanging heavy items fall downwards on the vertical extension line of the pedestal base 10, so that the invention is able to achieve a great effect of anti-slippage and enhance the steadiness of hanging a heavy item thereon.

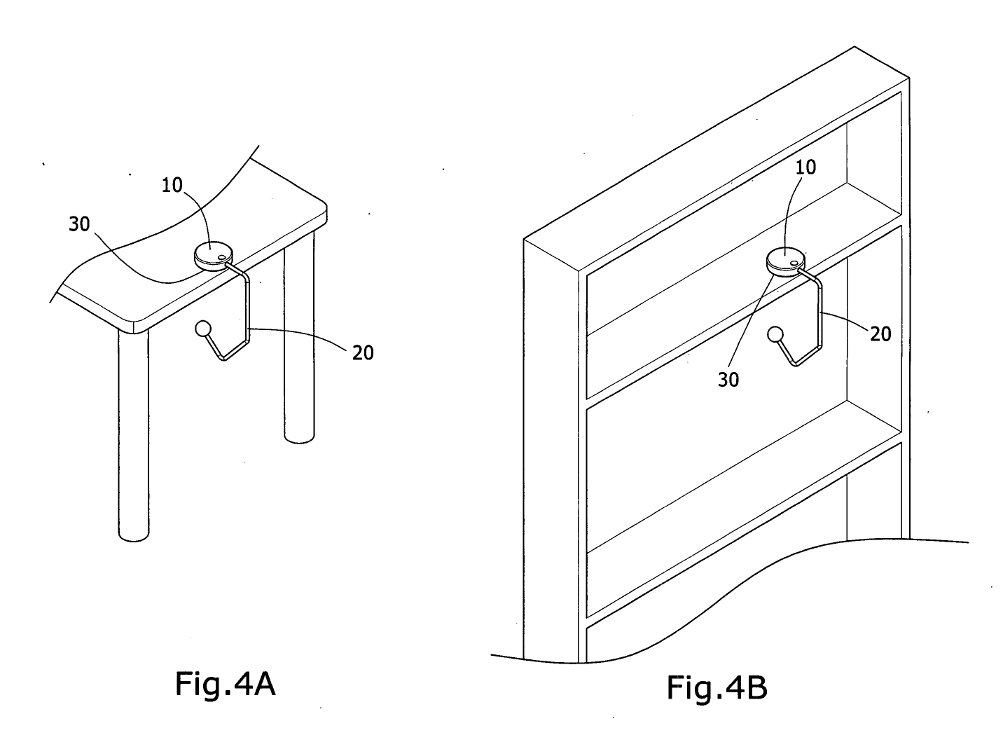

With reference to FIGS. 4A and 4B, the pedestal base 10 of the invention is applied to hang collected stationery or adornments by a table or on a rack. Therefore, when an object is hung on said hook 20, the gravity received by the hook 20 is passed down to the pedestal base 10, the weight of which is above 24 gm and the area of which is above 3 cm. The pedestal base 10 supports the whole weight of the object on the hook with a certain measure of area and weight of itself which said anti-slip portion 30 is made of rubber with high friction and set on the bottom of the pedestal base 10. Consequently, the area and the weight of the pedestal base 10 enables an object to be hung on the hook with more stability.

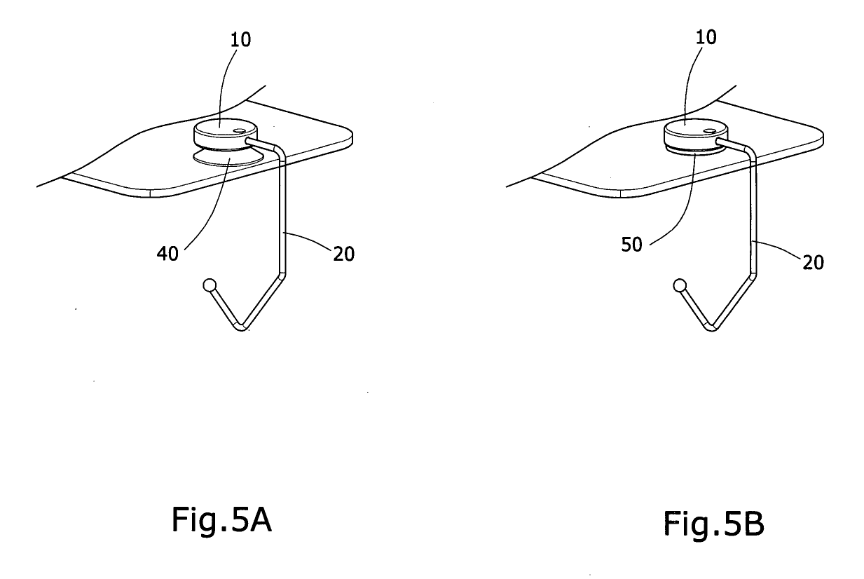

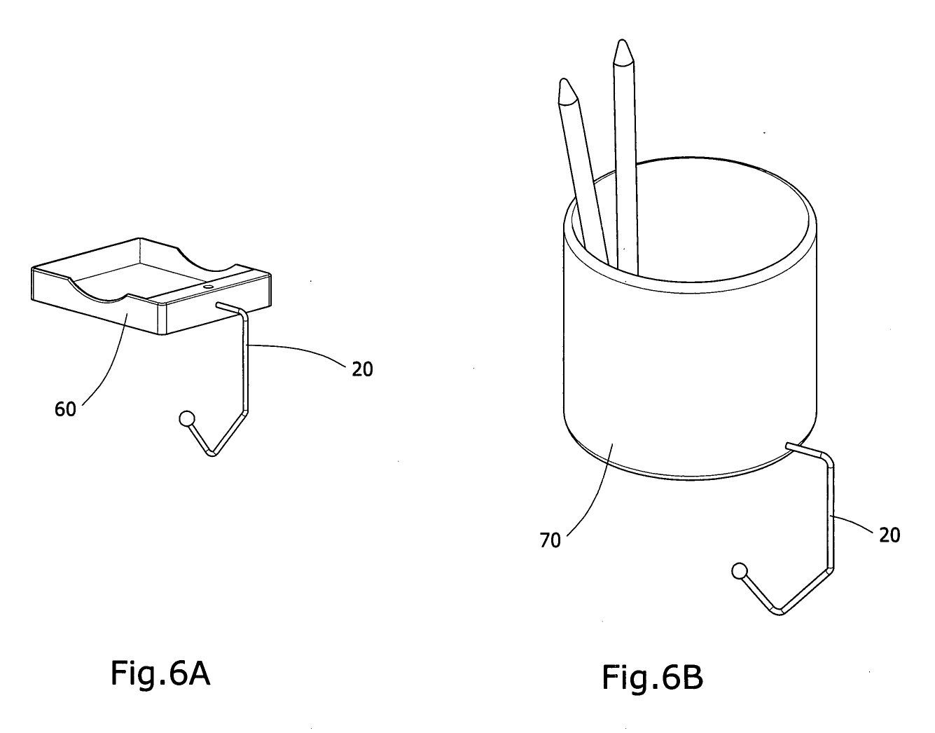

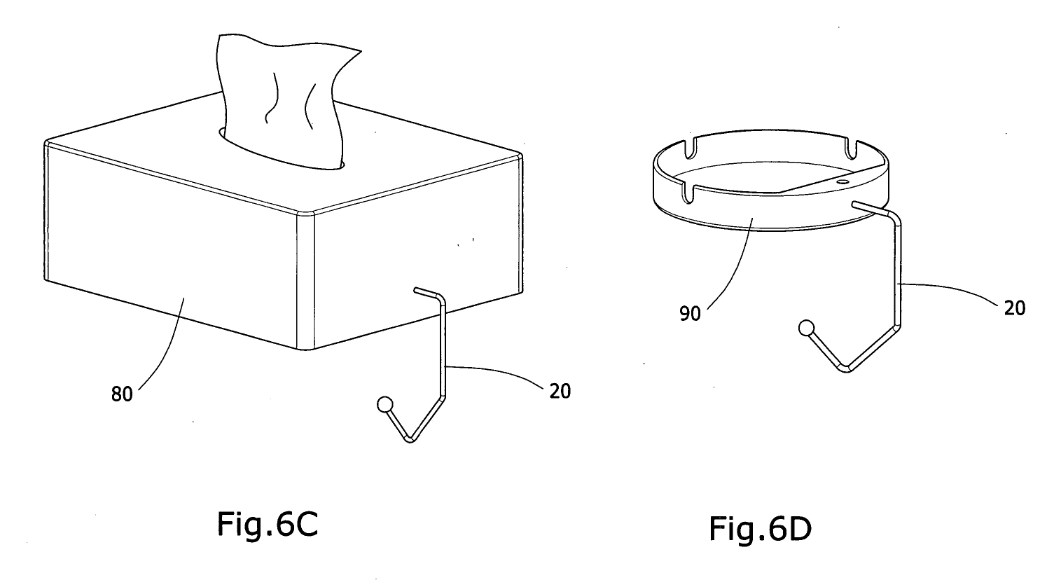

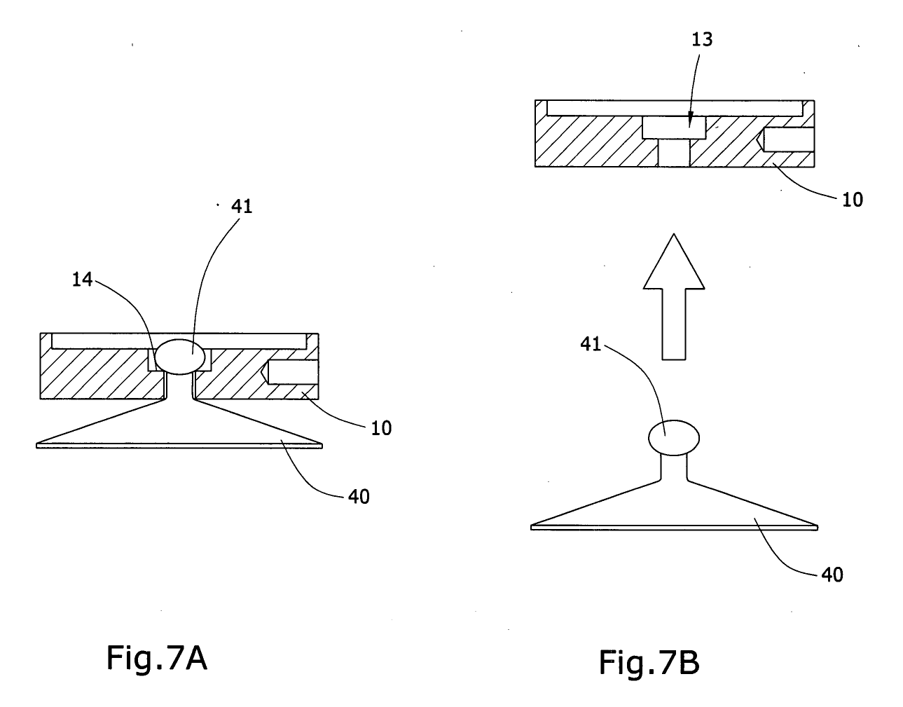

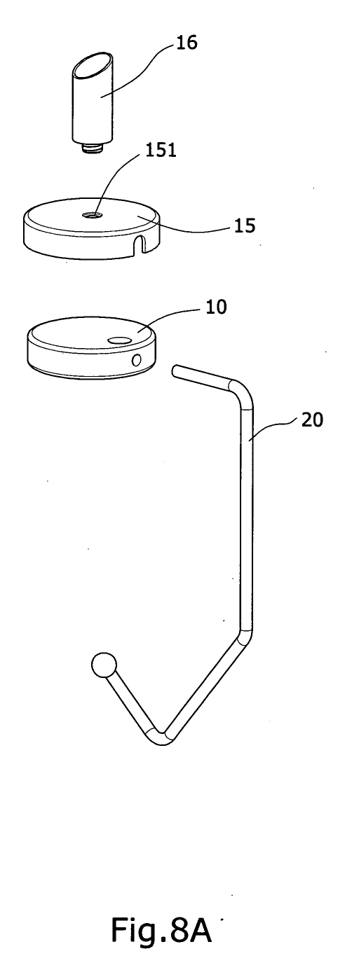

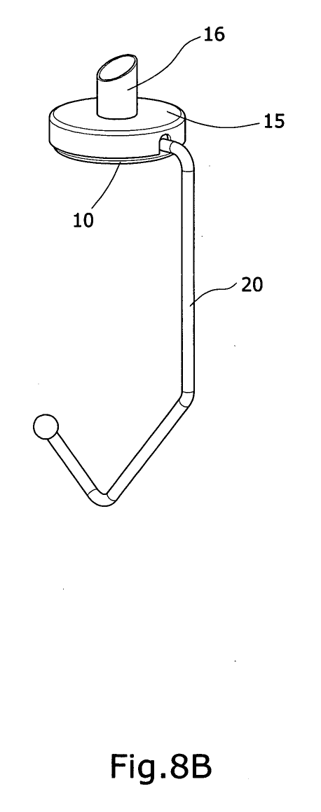

With reference to FIGS. 5A and 5B, the another embodiment of the invention shows that the bottom of the pedestal base 10 is able to be replaced by a suction 40, a magnet 50, or other object with stronger adhesion (as shown in FIGS. 6A, 6B, 6C and 6D). Moreover, the pedestal base 10 is able to be made as an article for daily use, such as a note box 60, a pencil can 70, a tissue box 80 or an ashtray 90, etc. (as shown in FIGS. 7A and 7B). Furthermore, the pedestal base 10 enables hole 13 and jammed portion 14 to be disposed in the middle thereof. The tip 41 of the suction 40 is able to pierce through on the bottom of the pedestal base 10, thereby enabling the suction 40 to be fixed in the jammed portion 14 of the pedestal base 10 (as shown in FIGS. 8A and 8B). The pedestal base 10 is able to add an upper lid 15 thereon, which set a bolt-hole 151 in the middle thereof by tapping, in addition, a sleeve 16 is disposed on the bolt-hole 151 for a pen or a socket to put therein. Consequently, the multifunctional hanger hook of the invention not only enables an object to be hung thereon, the pedestal base of the invention is a structure that has more functions, increase the weight and save space, enabling the hook to be more steady when hanging an object thereon.

To sum up, the “multifunctional hanger hook” of the invention has the effect of supporting great effect of anti-slippage and enhancing the steadiness of hanging heavy item thereon. The invention, therefore, possesses the “practicability” and “advancement” in the industry field.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A “multifunctional hanger hook”, comprising of a pedestal base and a hook with certain measure of areas and weights, respectively; the characteristic lies in: an anti-slip portion is made of rubber with high friction and set on the bottom of the pedestal base, a cavity is disposed on the upper surface of the pedestal base near to the rim thereof, a perforation penetrates through the cavity on a lateral side of the pedestal base; the hook is formed as an inverted hook, having said perforation pierced inward into the front end thereof, having a connection formed in the end thereof lodging in said pedestal base in one piece, in addition, forming a short upright section on the front end thereof, extending a longer upright section downwards at 90 degrees, extending a short and slanting curve downwards, and finally, extending a hook shape upwards at the end thereof, a round tip is disposed on the end of the hook, the pivot of which for hanging heavy items fall downwards on the vertical extension line of the pedestal base, thereby enabling the hook to achieve a great effect of anti-slippage and enhance the steadiness of hanging a heavy item thereon.

2. The “multifunctional hanger hook” of claim 1, wherein the anti-slip portion set on the bottom of the pedestal base is able to be replaced as suction or a magnet.

3. The “multifunctional hanger hook” of claim 2, where the pedestal base has the middle thereof set a hole and a jammed portion; the tip of the suction is able to pierce through the bottom of the pedestal base, enabling the suction to be fixed in the jammed portion of the pedestal base.

4. The “multifunctional hanger hook” of claim 1, where the pedestal base can be a note box, a pencil case, a tissue box or an ashtray.

5. The “multifunctional hanger hook” of claim 1, where the pedestal base is able to add an upper lid thereon, which set a bolt-hole in the middle thereof; and a sleeve, is able to be screwed onto the bolt-hole for a pen or a socket to put therein.
